(19) United States
(12) Patent Application Publication
(10) Pub. No.: US 2012/0168468 A1
(43) Pub. Date: Jul. 5, 2012

(54) AUTOMATIC PEPPER SPRAYER FOR BURGLARPROOF SYSTEM

(76) Inventor: Chi-Hsiang WANG, Xinbei City (TW)

(21) Appl. No.: 12/983,670

(22) Filed: Jan. 3, 2011

(51) Int. Cl. B67D 3/00

(52) U.S. Cl. 222/504

(57) ABSTRACT

The present invention discloses an automatic pepper sprayer for burglarproof system has a casing, a pepper air cylinder mounted inside a lower space of the casing and a solenoid mounted inside an upper space of the casing. A spray nozzle of the pepper air cylinder is aligned with an opening of the casing that is communicated with the lower space. A lower part of a shaft of the solenoid protrudes from a bottom side to presses against the spray nozzle of the pepper air cylinder. The solenoid is driven the upper part of the shaft is attracted downwardly when the burglarproof system detects abnormal signal. At the time, the lower part of the shaft further extends downwardly to press the spray nozzle, so the spray nozzle sprays the pepper air outwardly through the opening of the casing. Therefore, the burglarproof system with the automatic pepper sprayer has an active defense capability.

### BACKGROUND OF THE INVENTION

1. Field of the Invention

The present invention relates to the field of a pepper sprayer, and more particularly to an automatic pepper sprayer for burglarproof system.

2. Description of Related Art

In general, a vehicle burglarproof system or a house burglarproof system generally includes different detectors, a controller, alarms, and a networking box. The detectors are respectively mounted on different entrances, such as door, window etc., and the controller is electronically connected to the detectors and the alarms. The controller drives the alarms to output lighting or audio alarm and outputs the alarm signal through the networking box to notify the security guard when any one of the detectors outputs abnormal status.

However, the vehicle burglarproof system and the house burglarproof system outputs only lighting or audio alarm to scare off to scare off criminals without having an active defense means. Thus, the safety of the present burglarproof system is not good.

To overcome these shortcomings, the present invention provides an automatic pepper sprayer for burglarproof system to mitigate or obviate the aforementioned problems.

### SUMMARY OF THE INVENTION

The main objective of the present invention is to provide an automatic pepper sprayer that spray pepper liquid to an illegal person after receiving an alarm signal from a burglarproof system.

The automatic pepper sprayer for burglarproof system has a casing, a pepper air cylinder mounted inside a lower space of the casing and a solenoid mounted inside an upper space of the casing. A spray nozzle of the pepper air cylinder is aligned with an opening of the casing that is communicated with the lower space. A lower part of a shaft of the solenoid protrudes from a bottom side to presses against the spray nozzle of the pepper air cylinder. The solenoid is driven the upper part of the shaft is attracted downwardly when the burglarproof system detects abnormal signal. At the time, the lower part of the shaft further extends downwardly to press the spray nozzle, so the spray nozzle sprays the pepper air outwardly through the opening of the casing.

Based on the foregoing description, the burglarproof system using the automatic pepper sprayer has an active defense capability.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of an automatic pepper sprayer in accordance with the present invention;

FIG. 2 is another exploded perspective view of the automatic pepper sprayer in accordance with the present invention;

FIGS. 3A and 3B are operational views of the automatic pepper sprayer in accordance with the present invention;

FIG. 4 is a detailed circuit of a burglarproof system connected to the automatic pepper sprayer in accordance with the present invention;

FIG. 5 is a schematic view of the automatic pepper sprayer used in a automatic vehicle burglarproof system; and

FIG. 6 is a schematic view of the automatic pepper sprayer used in a house burglarproof system.

### DETAILED DESCRIPTION OF THE PREFERRED EMBODIMENT

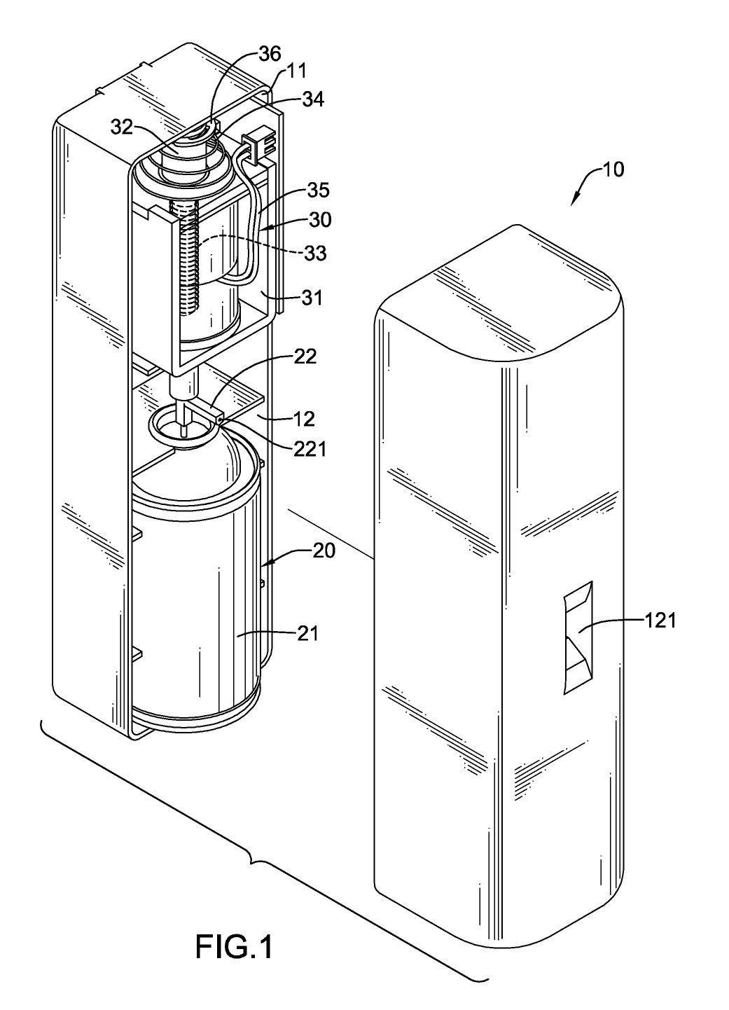

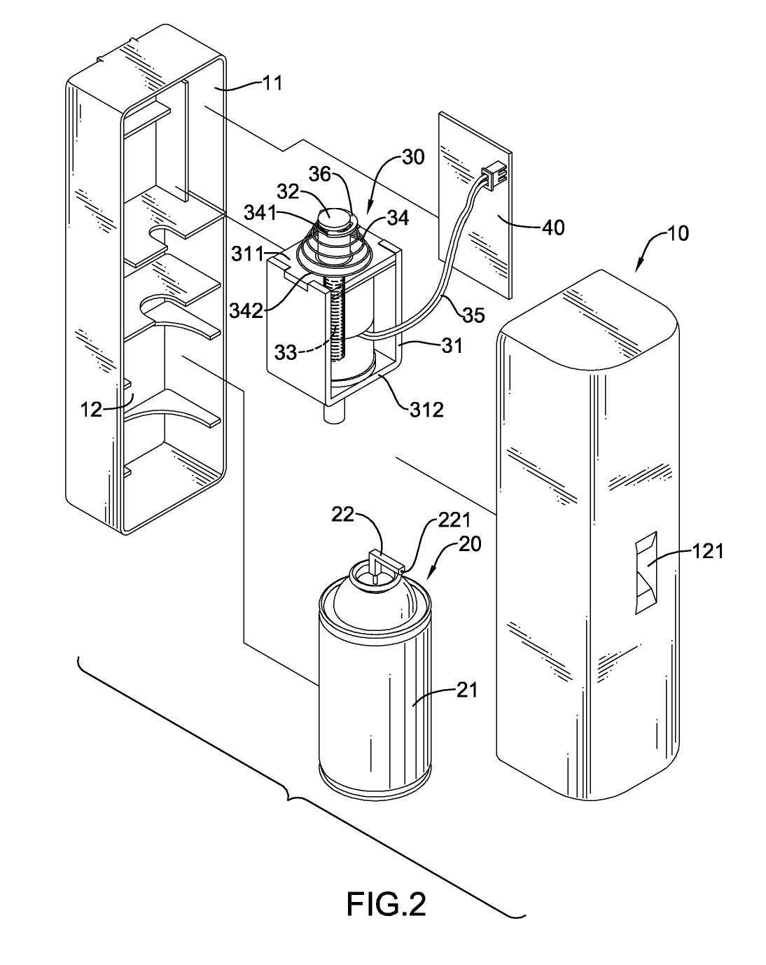

With reference to FIGS. 1, 2 and 3A, an automatic pepper sprayer in accordance with the present invention has a casing 10, a pepper air cylinder 20 and a solenoid 30.

The casing 10 has an upper space 11, a lower space 12 and an opening 121 defined through the casing 10 and communicated with the lower space 121.

The pepper air cylinder 20 mounted inside the lower space 12 of the casing 10 and has a bottle body 21 with pepper air and a L-shaped spray nozzle 22 with an air outlet 221. The air outlet 221 of the spray nozzle 22 is aligned with the opening 121 of the casing 10. When the spray nozzle 22 is pressed downwardly, the spray nozzle 22 sprays the pepper air outwardly through the opening 121 of the casing 10.

The solenoid 30 is mounted inside the upper space 11 and has a housing 31, a shaft 32, a coil 33, a taper spring 34 and two power wires 35. The shaft passes through the housing 31 and has two ends. One end protrudes from a top side 311 of the housing 31 to press against to a top face inside the upper space 11 of the casing 10, and the other end protrudes from a bottom side 312 of the housing 31 to presses against the spray nozzle 22. The coil 33 mounted around a part of the shaft 32 inside the housing 31 and electronically connected to the power wires 35. The taper spring 34 is mounted around a part of the shaft 32 protruded from the topside 311 of the housing 31. A small end 341 of the taper spring 34 is mounted to the part of the shaft 32 protruded from the top side 311 of the housing 31 by a C-ring 36, a large end 342 freely presses against the top side 311 of the housing 31.

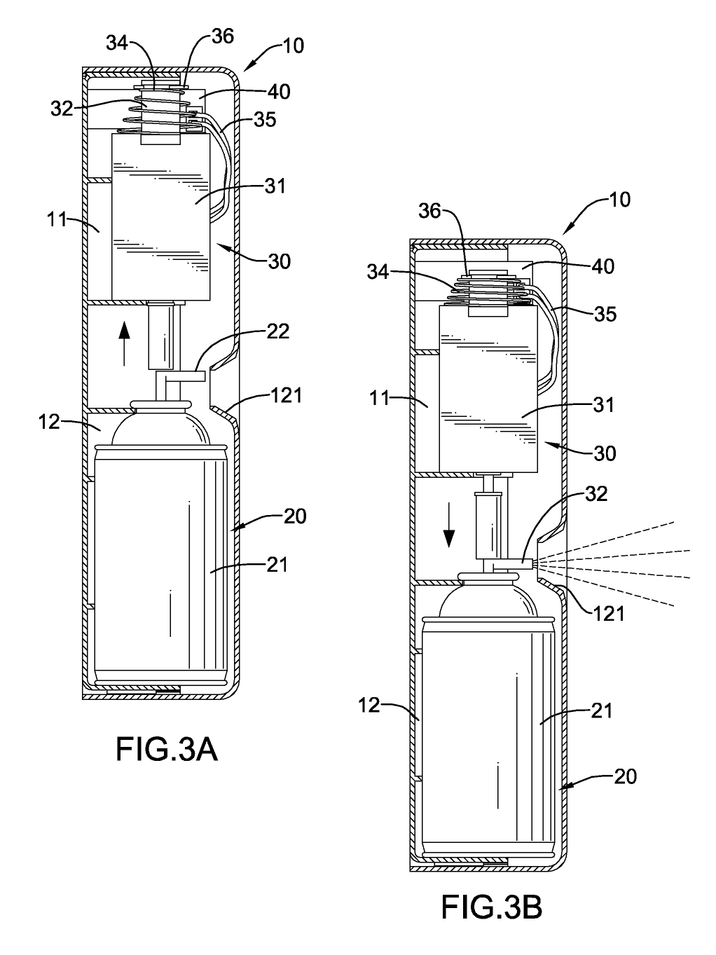

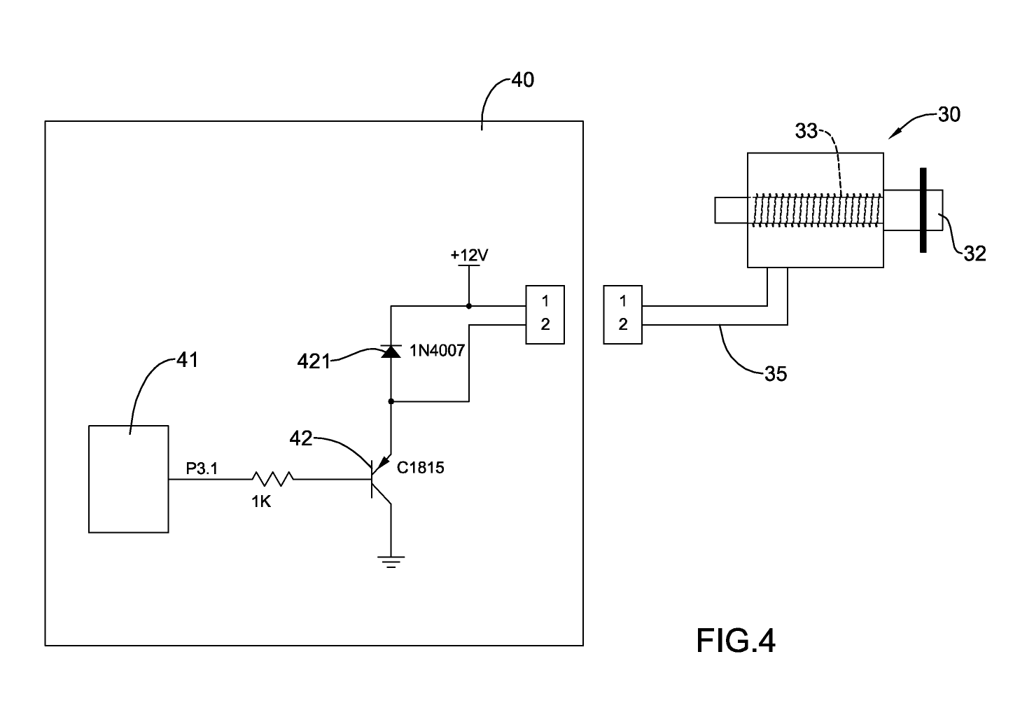

With reference to FIG. 4, a controller 40 of a burglarproof system is electronically connected to the power wire 35 of the solenoid 30 of the automatic pepper sprayer. The controller 40 of the burglarproof system generates an alarm signal and then output to the solenoid 30 through the power wires 35 when the burglarproof system detects an illegal person. The alarm signal triggers the coil 33 inside the solenoid 30, the part of the shaft 32 protruded from the topside 311 of the housing 31 is attracted downwardly and the taper spring 34 is compressed. With further reference FIG. 3B, the part of the shaft 32 protruded from the bottom side 312 of the housing further extends to press down the L-shaped spray nozzle 22, so as to spray the pepper air from the opening 121 of the casing 10. When the controller 40 stops outputting the alarm signal, the coil 33 of the solenoid 30 is not triggered and the compressed taper spring 34 is released and pulls the shaft 32 upwardly. Therefore, the shaft 32 does not press the spray nozzle 22, as shown in FIG. 3A.

The controller 40 has a processor 41, a transistor 42, a diode 421 and power connector 43. The transistor 42 is electronically connected to DC power (+12V) in serial through the diode 421 and driven by the processor 41. The power connector 43 is connected to the DC power (+12V) and the transistor 42 and used to connect to the power wires 35 of the solenoid 41. When the processor 41 drives the transistor 42 to turn on, the DC power (+12V) outputs to the power wires 35 through the power connector 43. On the contrary, when the transistor 42 turns off, the DC power (+12V) is not output to the power wire 35. Further the processor 41 determines to drive the transistor 42 to turn on or off based on detecting signal from the burglarproof system.

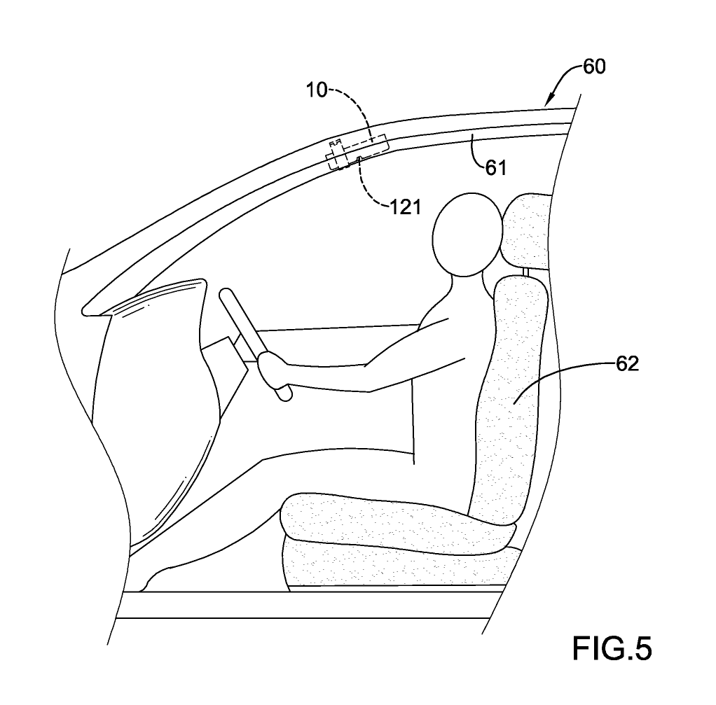

With further reference to FIG. 5, a vehicle burglarproof system inside the vehicle 60 uses the automatic pepper sprayer mounted on inside wall of a car roof 61, and the opening 121 of the casing 12 is aligned with the driver's position 62. Since the vehicle burglarproof system detects whether illegal person is stealing the vehicle 60 and further outputs the detecting signal, the processor 41 of the controller 40 of the burglarproof system determine to trigger the coil 33 of the solenoid 30 of the automatic pepper sprayer. When the vehicle burglarproof system detects that the illegal person appears inside the vehicle 60, the controller 40 drives the automatic pepper sprayer spray the pepper air and stops the illegal person steal the vehicle 60.

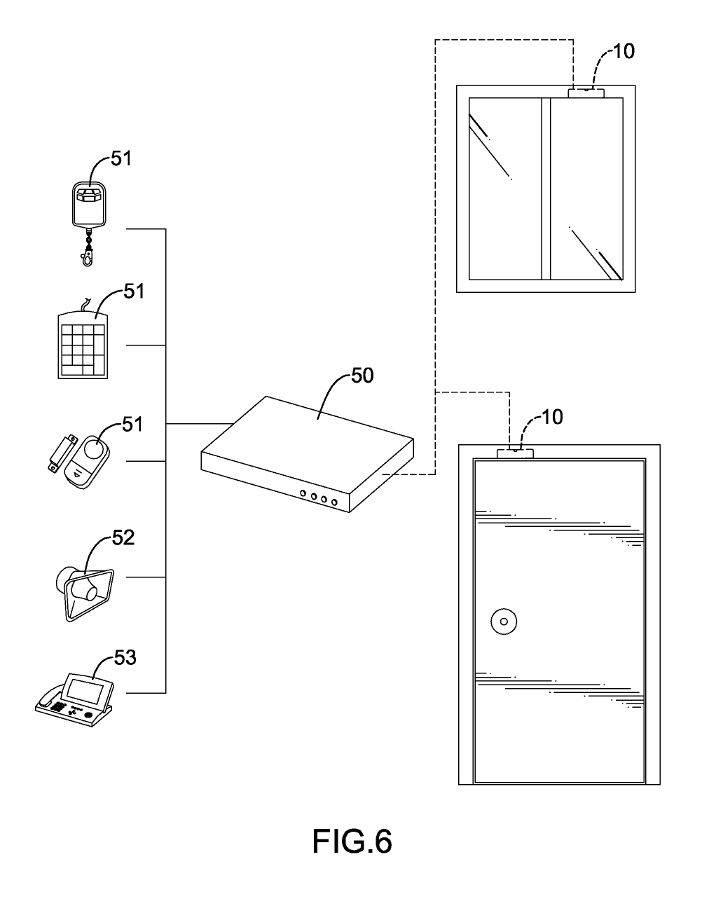

With reference to FIG. 6, a house burglarproof system 50 having detectors 51, alarms 52 and the automatic pepper sprayer mounted on a door or window and the opening of the casing 10 is aligned with an entrance of the door or window. When the illegal person tries to enter inside the house from the door or window, the automatic pepper sprayer sprays the pepper air to the entrance and stops the illegal person entering into the house.

Based on the foregoing description, the automatic pepper sprayer is combined with burglarproof system, so that the burglarproof system has an active measure to increase safety of the burglarproof system.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. A an automatic pepper sprayer for burglarproof system, comprising:
a casing having an upper space, a lower space and an opening defined through the casing and communicated with the lower space;
a pepper air cylinder mounted inside the lower space of the casing and having:
a bottle body with pepper air; and
a L-shaped spray nozzle with an air outlet mounted on a top of the bottle body and the air outlet of the spray nozzle aligned with the opening of the casing; and
a solenoid mounted inside the upper space and has a housing, a coil, a solenoid mounted inside the upper space and having:
a housing;
a shaft passing through the housing and having two ends, wherein one end protrudes from a top side of the housing to press against to a top face inside the upper space of the casing, and the other end protrudes from a bottom side of the housing to presses against the spray nozzle;
a coil mounted around a part of the shaft inside the housing;
a taper spring mounted around a part of the shaft protruded from the top side of the housing and having a small end mounted to the part of the shaft protruded from the top side and a large end freely presses against the top side of the housing; and
two power wires electronically connected to the coil.

2. The automatic pepper sprayer for burglarproof system as claimed in claim 1, wherein the small end of the taper spring is mounted to the part of the shaft protruded from the top side of the housing by a C-ring.

3. The automatic pepper sprayer for burglarproof system as claimed in claim 1, further a controller electronically connected to power wires and having:
a processor receiving an external detecting signal;
a transistor electronically connected to DC power in serial through a diode and driven by the processor; and
a power connector is connected to the DC power, the transistor and the power wires of the solenoid;
whereby the processor drives the transistor to turn on, the DC power outputs to the power wires through the power connector; on the contrary, when the transistor turns off, the DC power is not output to the power wire.
